(19) United States
(12) Patent Application Publication
(10) Pub. No.: US 2016/0227629 A1
(43) Pub. Date: Aug. 4, 2016

(54) RETROFIT LAMP WITH DIRECT DIGITAL CONNECTION

(71) Applicant: Luxapel, LLC, Portland, OR (US)

(72) Inventors: Arlie Conner, Portland, OR (US); Oke Tammik, Portland, OR (US)

(73) Assignee: LUXAPEL, LLC, Portland, OR (US)

(21) Appl. No.: 14/613,650

(22) Filed: Feb. 4, 2015

(51) Int. Cl. H05B 37/02; H05B 33/08

(52) U.S. Cl. CPC H05B 37/0254; H05B 33/0845; H05B 33/0857

(57) ABSTRACT

An illumination system uses a plurality of lamps with each lamp including a modular connector configured for connecting to a streaming data signal. Each lamp further includes an enumerating feature, with a second modular connector, so that a series or array of such lamps can be daisy-chained and thus connected to a control signal such as using the DMX512 standard. Each lamp is intended to retrofit a border light fixture in a stage, studio or entertainment lighting application. The enumeration of each lamp can be done by fixed assignment in the microprocessor nonvolatile memory, or by means of a dual-inline packaged switch bank (DIP switch), or by other electronic or electro-mechanical means. Such numbering is needed to allow each retrofit lamp to have a unique unit number so that it can be specifically addressed and get dimming instructions independently from other retrofit bulbs that share the same data stream.

### BACKGROUND OF THE INVENTION

This invention relates generally to lighting and more particularly to network-controlled stage lighting.

Historically a ‘border light’ has been used to create a background effect on the curtain or cyclorama of the cabaret or stage. Whether the venue is large or small, it is desirable to have a row of lights hanging overhead and pointing downward to create a mood or background or theme by selecting the right combination of colors. There might also be a need for a row of lights at the front of the stage pointing up (footlights), also used to create a dramatic mood to front-light the stage or curtain or the actors.

There are thousands of venues using Borderlights made by Altman Lighting Co. Inc of Yonkers, N.Y., (and similar fixtures made by other companies), which are generally installed over the stage area with typically 48 to 80 sockets, most often populated with 150 W halogen PAR38 or 250 W R40 bulbs with each bulb having a gelatin color filter ‘gel’ in front of it, so as to render each bulb's light beam a specific color. The combination of red, green and blue (R,G,B) gels, with each lamp having a different color primary, and, and by adjusting the phase angle of a triac-dimmer connected to each lamp, can create most any color on the curtain or stage, including white.

In many configurations, the pre-existing fixture might be a linear array of sockets in a steel trough or may instead be a row of PAR38 ‘can’ fixtures, each containing one light bulb using an Edison socket base. The wiring can be made to individual dimmers, or grouped in a fashion such that the red bulbs for instance may be connected to a first dimmer circuit, the green bulbs connected to a second dimmer circuit and the blue bulbs connected to a third circuit. In the latter case, the lighting operator can dim or adjust the relative brightness of the red, green and blue sets independently using 3 control knobs or sliding potentiometers on the lighting control board or using ‘soft sliders’ i.e. touch-controlled, via computerized lighting control application software. In this fashion the array of RGB bulbs become a unified full color fixture, in the sense that they are controlled together as a set and any mixture of colors can be dialed in, remembered (stored as a preset) and recalled as needed.

The dimming control using a triac for each lamp has drawbacks, among them audible noise, heat generation and cost. A far better solution is to build the dimming circuitry into each lamp, and allow a direct digital communication from the controller to the light bulb.

With the advent of solid state lighting, the dimming is typically an included feature of the driving circuit and so there is no added cost to implement the light control by this means. In the original border light system there are several triac ‘dimmer packs’ which are connected by means of DMX-512 cables so as to group or gang the dimming using only a few controls at the lighting board.

The DMX512 standard (For “Digital Multiplex Interface with 512 Pieces of Information”) was created in 1986, with subsequent revisions in 1990 leading to USITT DMX512/1990. A revised standard, known officially as “Entertainment Technology—USITT DMX512-A—Asynchronous Serial Digital Data Transmission Standard for Controlling Lighting Equipment and Accessories”, was approved by the American National Standards Institute (ANSI) in November 2004. It was revised again in 2008 and is now maintained by the Professional Lighting and Sound Association (PLASA), which has offices in Eastbourne, United Kingdom and New York City, USA.

There are options to replacing an entire border light fixture, for example using solid state strip lights such as Color Force 72™, sold under the Chroma-Q® brand name by A.C. Lighting of Toronto, Canada or the Vivid-R SELVR63 strip light made by ETC Selador of Middletown, Wis. These products require that the existing strip light fixture be removed. However, it would be desirable to redeploy and reuse the original strip light fixture, avoiding the waste of material, and, in any case, some smaller venues cannot afford to upgrade to an expensive new product. For a 60 foot wide curtain, to replace an existing border light, there would be 20 sections of 3 foot bars to install, at a cost of about $1000 per foot—is a huge capital purchase for a small theater company. Thus, a lower cost true retrofit solution is needed.

Presently there is no product in the market that can be used to directly replace border light incandescent lamps using the Edison screw base socket.

Accordingly, there is a need in theatre, stage, studio and architectural environments for a full color lighting system that can create a wall wash, illuminate a curtain or cyclorama, or make a background color for a stage and performers that overcomes some of these drawbacks in the art.

### SUMMARY OF THE INVENTION

It is object of the present invention to create a high performance and economical solid-state replacement or upgrade for stage and studio border light apparatus. The present invention offers a means for replacing the bulbs themselves, while keeping the infrastructure of the border light and thus making possible the same kind of special effects (as well as added levels of control for effects previously unknown with traditional incandescent lighting), that have been relied on for a century in the field of theatre lighting. Accordingly, we disclose an array of solid state directional light bulbs that are compatible with Edison base sockets but which are also uniquely equipped with direct digital connectors for easy control using standard stage light wiring and protocols.

The invention is a retrofit light bulb, compatible with existing strip light fixtures. The replacement system includes interconnection hardware so that cables can be installed to connect each lamp to a standard DMX512 control signal so as to reproduce, and improve upon, the behavior of the original tungsten/incandescent border light. Each lamp in the series can have perfectly repeatable brightness settings by virtue of the digital communication and dimming control circuitry, so that a strip of 12 bulbs, e.g. Red Green Blue Red Green Blue Red Green Blue Red Green Blue, will not vary across the array (i.e. the red lamps all look the same and the combined additive color is uniformly displayed) ensuring that the strip will not exhibit noticeable brightness or color deviations.

The present solution uses a modular connector on each lamp to connect to a streaming data signal, and included in each lamp is an enumerating feature, and each lamp also includes a second modular connector so that a series or array of such lamps can be daisy-chained and thus connected to one control signal, most often DMX512. The enumeration can be done by fixed assignment in the microprocessor nonvolatile memory, or by means of a dual-inline packaged switch bank (DIP switch), or by other electronic or electro-mechanical means. Such numbering is needed to allow each retrofit lamp to have a unique unit number so that it can be specifically addressed and get dimming instructions independently from other retrofit bulbs that share the same data stream.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

This invention is described with respect to specific embodiments thereof. Additional features can be appreciated from the Figures in which:

FIG. 1 shows a wiring diagram in schematic format, where a plurality of retrofit light bulbs are connected together in daisy-chain fashion according to aspects of the invention;

FIG. 2 is a perspective view of an implementation of a retrofit light bulb configured according to a first embodiment of the invention, said embodiment having an Edison E-26 screw base and a pair of RJ-45 modular jacks, and a DIP switch fitted within an enclosure;

FIG. 3 is a schematic diagram illustrating a series connected array of retrofit light bulbs illuminating in partially overlapping fashion on a common surface;

FIG. 4 shows a schematic diagram of the individual retrofit light bulb of FIG. 2; and

FIG. 5 shows an alternate schematic block diagram of the individual retrofit light bulb of FIG. 2.

### DETAILED DESCRIPTION

The present invention relates to strip lighting or other arrays or arbitrary arrangements of illumination systems. In particular, the present invention allows an LED based light source to replace a halogen or tungsten/incandescent lamp for improved efficiency, color control, more accurate dimming values and faster response times.

The disadvantages of existing systems are well-known. Filament lamps have poor response times and low efficacy. Triac dimmers have poor reliability as they handle hundreds of watts and can burn out or otherwise fail during a performance. In contrast, solid state lighting systems are as much as ten times more power efficient and if properly designed can have a higher reliability compared to filament lamps and triac dimmers.

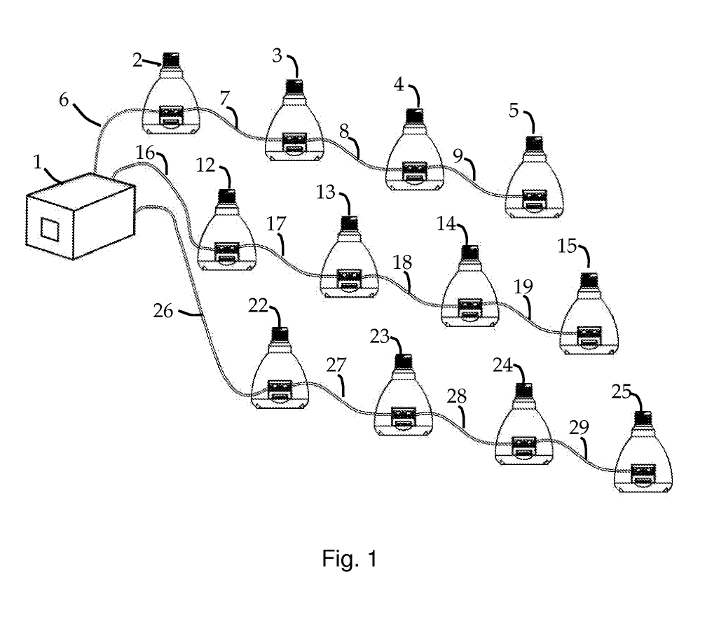

FIG. 1 shows a wiring diagram, where a controller 1 is connected to a plurality of cables 6, 7, 8 and 9 and these cables, having at least one twisted pair of conductors and according to one embodiment using Category 5 type construction are connected between each retrofit light bulb 2, 3, 4 and 5 in daisy-chain fashion. This border light system is comprised of a plurality of retrofit lighting modules which create spatially overlapping regions of multicolor lighting to create a background illumination.

Referring again to FIG. 1, a retrofit lighting unit 2 is interconnected to a second retrofit lighting unit 3 which is interconnected to a third retrofit lighting unit 4, which is interconnected to a fourth retrofit lighting unit 5. By using the preferred DMX512 protocol, all lighting elements are slaved to a master controller 1 which can drive dimming or color changing instructions to a ‘universe’ of retrofit lighting elements and thus cause any imaginable sequence of illumination to occur, limited only by the skill of a lighting designer and the control software.

FIG. 1 also illustrates how it is possible to arrange groups of retrofit light bulbs, and for instance dedicated red LED-based lamps on the first string, dedicated green-LED based lamps on the second string and dedicated blue-LED based lamps on a third string. By interleaving the positions of the R, G and B light bulbs, it is possible to perfectly emulate the classical vintage look and operation of the incandescent border-light, which might have used red, green and blue gels in RGBRGB sequence. In the case of retrofit light bulbs 2, 3, 4 and 5 being red-LED type bulbs we also show in FIG. 1, controller 1 being independently connected to a plurality of cables 16, 17, 18 and 19 and which are connected between each retrofit light bulb 12, 13, 14 and 15 in daisy-chain fashion, and may be selected to be green-only LED light bulbs. Additionally, the controller is connected to a plurality of cables 26, 27, 28 and 29 and these are connected between each retrofit light bulb 22, 23, 24 and 25 in daisy-chain fashion, and may be selected to be blue-only LED light bulbs.

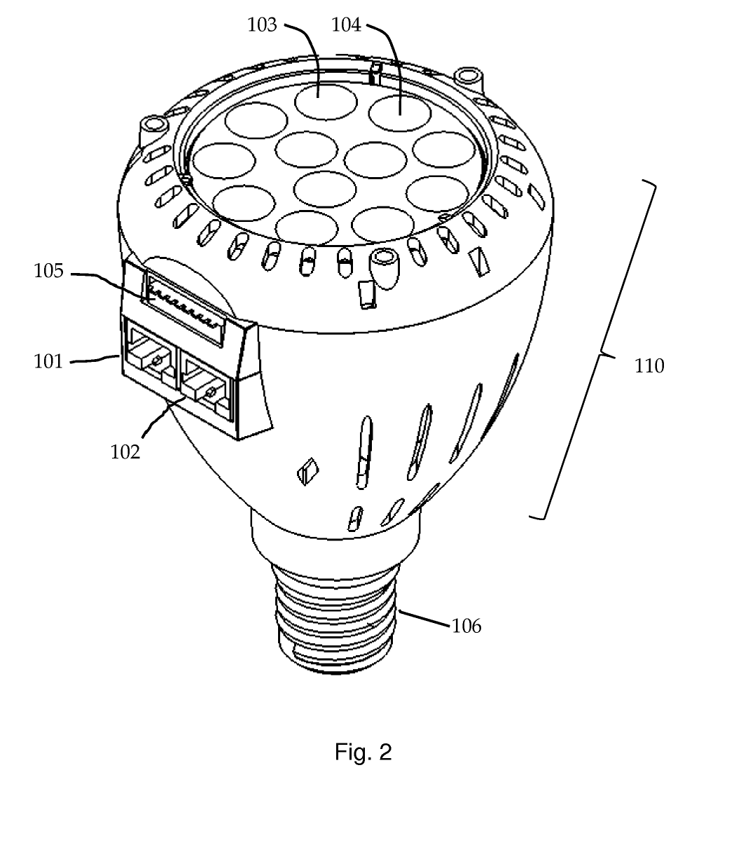

A retrofit light bulb assembly is shown in FIG. 2, with two RJ45 modular jacks 101, 102 to enable interconnection to control signals such as can be delivered by a Category 5 (Cat5) cable as defined in EIA and ANSI specifications ANSI/TIA/EIA-568-A and EIA-568-B. The output surface of the light bulb has a plurality of lenses 103, 104, one for each LED (not shown) to produce narrow light beams which will overlap at the object being illuminated.

Other control and communication modes may also be used, such as Gigabit Ethernet, I2C, RS-232, and RDM, or future modes of signaling. DMX512 and RDM (Remote Device Management, “ANSI E1.20, Remote Device Management Over DMX512 Networks”) are built on RS-485, an ANSI standard serial-communication protocol.

It will be appreciated that the interconnection of the lighting components can be made arbitrarily. The addressing of each component is unique, since each component can be given a unique ID number, according to DMX512 standard methodology or as in the case of the alternate protocols, for instance using Gigabit Ethernet, each component may have a unique MAC address. A serial number embedded in the microcode may also act as a unit ID. In a preferred embodiment the lighting designer can set the desired unit number by means of miniature switches, for instance a DIP switch array 105 in FIG. 2, user-accessible at the outer rim of the retrofit light bulb. By virtue of the unique addresses, each lighting component can be given instruction to execute its own special sequence of dimming, including fades and progressions, so that, when appropriately coordinated, the lighting system can create a compendium of special effects, at the very least including gradual color changes that can create a dramatic or subtle theatrical effect.

In particular the combination of red, green and blue light bulbs made according to the invention will produce a ‘balanced white’ light when all lamps are lit with specified relative drive levels or dimming values. A high precision of dimming has been attained with the advent of digitally controlled lighting. Basic digital electronic control is easily achieved in current practice, allowing setup and recall of scenes and lighting environments having absolute accuracy and excellent repeatability. It is a requirement that the retrofit lamps of this invention be dimmable with high accuracy and that their individual color primaries be stable and repeatable so that any desired color can be created (and stored and later recreated) by the lighting designer and the controlling equipment.

The screw socket base 106 allows easy upgrading and retrofitting to an existing strip light fixture. In total, the lamp shown in FIG. 2 has a first (input) modular jack 101 for accepting a streaming command signal, a second (output) modular jack 102 for passing the signal to a second bulb (not shown), and an Edison screw base 106 configured to connect the bulb to the power grid. It will be appreciated that this configuration of a retrofit bulb makes upgrading a border light an easy matter.

The packaging of the LED lighting assembly can be in a familiar form factor body 110 such as a PAR30 or PAR38 shape having an Edison E26 or E27 screw base 106, to emulate and replace such venerable bulbs from the tungsten lighting era. By adding the direct connection using modular RJ45 jacks 101, 102, the multi-color-component retrofit bulb can be adjusted in brightness or light output and in hue by simple commands and straightforward built-in dimming circuitry.

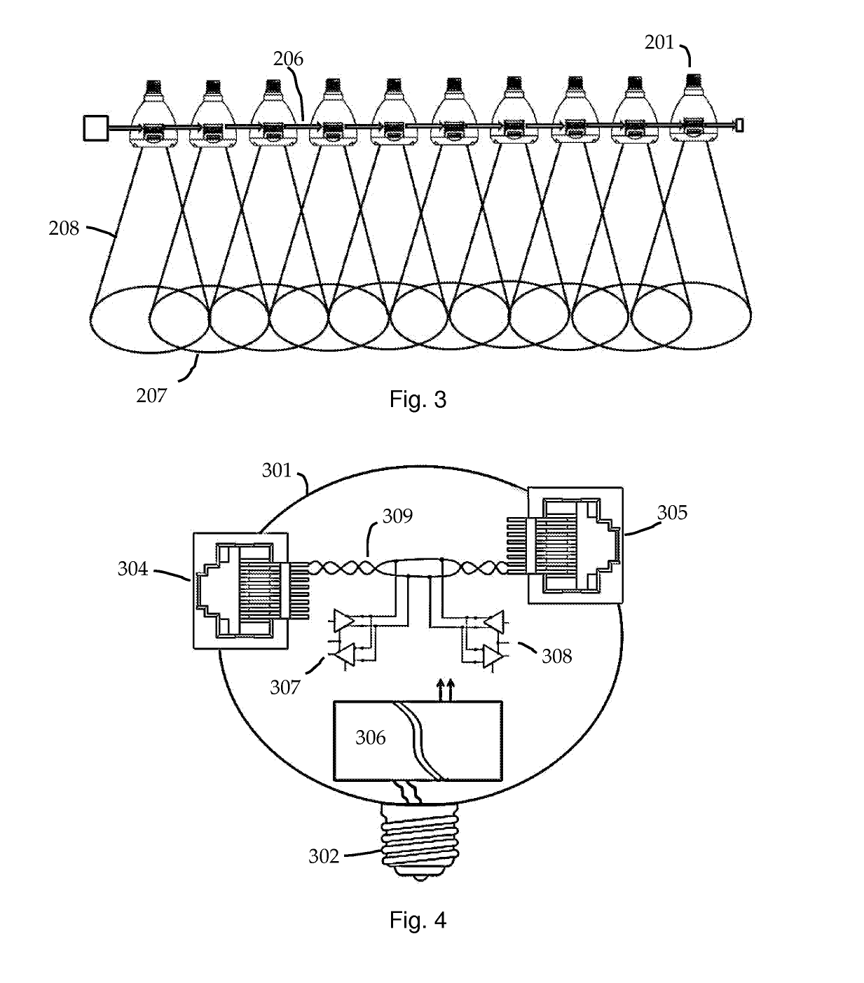

Referring to FIG. 3, a Category 5 (Cat5) cable 206 is a preferred connection means between retrofit lighting units, to facilitate daisy-chaining of an array of such lamps as is common in high speed communication methods wherein the cabling uses twisted-pair wires to propagate the control signals. The array of retrofit lamps is, in this embodiment, placed in a closely spaced line to create an illumination ellipse 207, built up from the overlapping light beams 208 from each lamp.

For a retrofit lamp, using an Edison socket, the most common method of control has been a dimming circuit, typically based on a triac or rheostat to globally reduce the power or voltage going to the lamp. Such apparatus is well known in stage lighting as well as within households and commercial/industrial spaces, and most retrofit lamps strive to allow some (limited or extensive) compatibility with standard dimming circuitry, however dimming operation with LED light bulbs is inconsistent and generally not suitable for accurate 0-100% stage light applications. This single-value control method is also not sufficient for a multicolor retrofit lighting instrument and thus a direct digital connection method based on DMX-512 protocol that can be delivered to each bulb via a CAT5 cable is preferred so that multiple color and brightness parameters can be accurately controlled. The use of a pair of modular jacks (RJ45) allows the multicolor lamps to be daisy-chained and a single twisted pair can control up to 256 lamps with typical RS-485 serial communication hardware, if properly driven and terminated. The number of lamps and the number of color channels is limited typically by line drop resistance, noise immunity as well as the DMX protocol. The time-tested DMX512 standard is ideally suited to control an array of colored lamps, e.g. a borderlight, but can be extended to more general bidirectional communication, e.g. using RDM (i.e. standard RS-485 bi-directional serial communication operation). Modular connectors and cables are inexpensive and highly rugged and reliable, and may be upgraded to waterproof or high reliability cables and connectors as might be needed mission-critical applications beyond stage and theater lighting areas. An alternate embodiment may use a subminiature connector with a small diameter twisted pair cable to serve the same purpose, but with less bulky components.

Another alternate embodiment allows the retrofit bulb to be powered through the modular connector, e.g. by a DC voltage, such that the Edison screw base is merely a mechanical means for locating and securing the retrofit assembly. In this case the old-fashioned base is vestigial, but facilitates the easy assembly of a strip light, or upgrade of any conventional screw base fixture, as it is not used for delivering AC power to the light bulb at all. In such case the Edison base might be insulating, i.e. not have any electrical connection to the mains. This embodiment would be more akin to Power over Ethernet (PoE), an emerging standard, but with the added feature of an Edison connector for mechanically retrofitting the lighting apparatus of this invention.

There is an approved standard for DMX over Cat5 cabling. Thus, in a preferred embodiment we employ two RJ45 jacks to allow DMX512 signals to be input to, and passed through, each retrofit lamp, so that a series connected string of such lamps can be controlled as a group or as individual elements, with each lamp occupying 3 or 4 DMX addresses (for RGB or RGBW) or in the case of individual color primary lamps, 2 addresses to control intensity and hue. Referring again to FIG. 2, the RJ45 connectors 101, 102 are placed on the outer rim of the PAR30 or PAR38 or other retrofit lamp to facilitate easy interconnection. A DIP switch 105 is placed above the RJ-45 jacks for easy ID number setting. Such enumeration procedure is generally done once, only at the beginning when wiring up an array of retrofit light bulbs.

A string of such lamps can be arrayed in a line, for instance as shown in FIG. 3, where a row of bulbs 201 are hung across the front of the stage or in a line facing downward near the top of the curtain, to create a uniform backdrop color. On the curtain or scrim or floor of the stage, the light beams overlap 207 due to appropriately defined beam angles 208 from each retrofit bulb. Because each lamp is individually enumerated, with appropriate control signals, such linear arrays can perform chases, washes, waves and other kinds of moving patterns without requiring any motion of the lighting elements. Undulating blue and green can imitate an ocean setting. Likewise, quickly changing red, orange and yellow flashes can imitate a flame or a house afire. The simpler interconnection of the incandescent border lights do not allow individualized dimming, strobing and fading and such complex patterns are harder to obtain as the gel filters are limiting, and the response time of a filament-based bulb is slower than the solid state retrofit of the subject invention.

It is an object of this invention to allow easy interconnection between a plurality of lighting elements that can be easily and quickly connected as a linear array or in any prearranged matrix, or indeed in any geometric arrangement that can be imagined, so that spiraling effects or dance-floor patterns, or hemispherical illumination systems are facilitated and each lamp can be considered a separate pixel element of a grand and extensive lighting system.

FIG. 4 illustrates a schematic of a preferred embodiment according to this invention, with a retrofit light bulb 301 having an Edison E-26 screw base 302, a pair of RJ-45 modular jacks 304 and 305, an AC-DC converting power supply 306 and two transceivers 307, 308. The transceivers are necessary to translate the voltage swings on the twisted pair lines into signals useful to the low-voltage microprocessor. Additionally such transceivers can protect the connected internal circuit from spikes, surges and electrostatic discharge. The DMX information is delivered as a series of digital pulses over the twisted pair wires 309 and passes through from one modular jack to the other modular jack if both are being utilized. The end of each series string should have a termination resistor inserted into the ultimate modular jack to prevent reflected signals from degrading the communication channel.

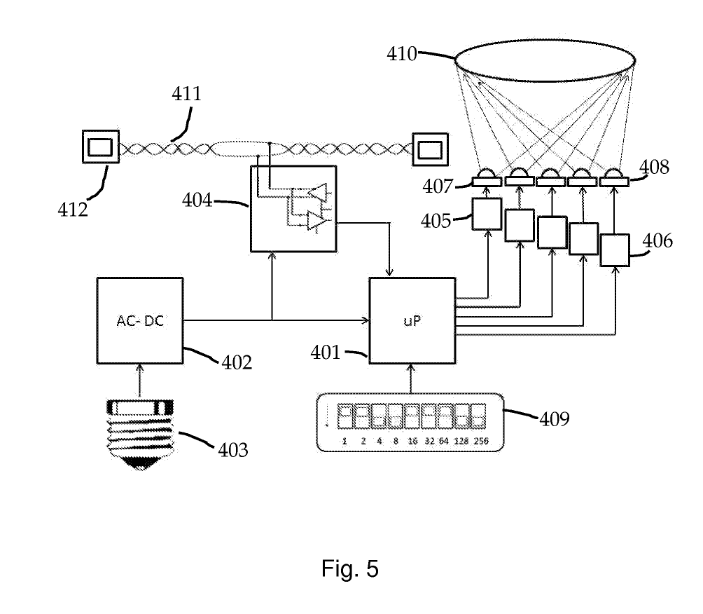

In FIG. 5, a block diagram shows a microprocessor 401 as connected to a power supply 402, which itself draws power from the mains via a screw-in socket base 403. The alternating power is converted to DC power by the power supply and this powers the other circuit elements, including the RS-485 transceiver 404, and a plurality of LED drivers 405, 406 which may energize and dim the associated LED 407, 408 according to the microprocessor's demand. A DMX address may be selected by DIP switch 409 and read by the microprocessor 401, so that when a DMX instruction is sent over twisted pair conductors 411, using a modular jack 412 and associated cabling (not shown) to this particular light bulb element (one of many in a series string for instance), this lighting element can change its light output of red, green, blue components, and combinations thereof to illuminate the stage or scene with a beam of colored light 410, with hue and intensity as may be required.

In an alternate embodiment, screw base 403 is used solely for mounting purposes where power is supplied through the modular jacks as via conductor 411.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A lighting system comprising:
an array of threaded Edison sockets;
a plurality of lamps, each lamp including a threaded connector configured to be received in a respective one of the Edison sockets, with each lamp including:
a first modular connector configured to connect to a streaming data signal;
a second modular connector configured to connect in series to an adjacent lamp coupled within the array of threaded Edison sockets; and
enumeration means allowing the lamp to be individually addressed and controlled as required;
wherein adjacent lamps are daisy chained together in at least one series via data cables coupled between first and second modular connectors of the adjacent lamps; and
a controller for controlling color and intensity output of each of the lamps via a data control signal transmitted to the lamps via the data cables.

2. The lighting system of claim 1, wherein the enumeration means includes nonvolatile memory of the controller configured to accept a fixed assignment of a unique number to each of the lamps so that it can be specifically addressed and get dimming instructions independently from other retrofit bulbs that share the same data stream.

3. The lighting system of claim 1, wherein the enumeration means includes a dual-inline packaged switch bank (DIP switch).

4. The lighting system of claim 1, wherein the data signal conforms to the DMX512 standard.

5. The lighting system of claim 1, wherein the array is a linear array with the plurality of lamps arranged to create an illumination ellipse built up from partially overlapping light beams emitted from each lamp.

6. A retrofit lighting device, comprising:
a lamp body;
a threaded connector coupled to a terminal end of the lamp body, the threaded connector configured to be received into an Edison socket;
illumination means within the lamp body;
a modular connector on the lamp body configured for accepting digital control data; and
means for controlling operation of the illumination means through the modular connector.

7. The retrofit lighting device of claim 6, wherein the illumination means is electrically coupled to the threaded connector for selectively powering the illumination means.

8. The retrofit lighting device of claim 6, the modular connector further configured to receive a power signal with the digital control data, wherein the illumination means is powered through the modular connector.

9. The retrofit lighting device of claim 6, further including a second modular connector configured to output the digital control data via cable to another lighting device.

10. The retrofit lighting device of claim 6, further including a DIP switch array disposed on an outer rim of the lamp body for setting a desired unit number for the lighting device for control through the modular connector.

11. The retrofit lighting device of claim 6, wherein the first and second modular connectors are disposed on an outer rim of the lamp body.

12. The retrofit lighting device of claim 11, further including a DIP switch array disposed on an outer rim of the lamp body for setting a desired unit number for the lighting device for control through the modular connector, wherein the first and second module connectors are closer to the threaded connector than the DIP switch.

13. The retrofit lighting device of claim 6, the illumination means further comprising:
a first LED light source configured to emit a first color of light; and
a second LED light source configured to emit a second color of light,
wherein the means for controlling operation of the illumination means includes means for selectively driving the first and second LED light sources to different brightness levels according to digital control data received through said modular connector.

14. The retrofit lighting device of claim 13, wherein an output surface of the lamp body includes a plurality of lenses, one for each of the first and second LED, to produce narrow light beams which will overlap at an object being illuminated.

15. A method of generating light, comprising the steps of:
applying a first potential to a first Light Emitting Diode (LED) to generate a first selected color;
applying a second potential to a second Light Emitting Diode (LED) to generate at least a second selected color; and
applying a third potential to a third LED to generate at least a third selected color and:
receiving a control signal by means of a modular connector and cable, and powering said LEDs and twisted-pair receiver by means of a power supply, which is connected to the electrical mains by means of a socket and base, said base being of the Edison screw-in type.

16. The method of claim 15, wherein the first, second, and third LED correspond to an individual primary color contained within a single lamp body.

17. The method of claim 16, further including the step of applying a unique address to each of the first, second, and third LEDs.

18. The method of claim 15, further including the step of receiving a control signal at a respective lamp having two unique addresses to control intensity and hue.
